(19) United States
(12) Patent Application Publication
(10) Pub. No.: US 2003/0096588 A1
(43) Pub. Date: May 22, 2003

(54) Receiver intermod enhancer

(76) Inventor: Ronald J. Vanderhelm, Surrey (CA)

Correspondence Address: ROBERT E. KREBS, BURNS, DOANE, SWECKER & MATHIS, L.L.P., P.O. Box 1404, Alexandria, VA, 22313-1404, US

(21) Appl. No.: 09/988,543

(22) Filed: Nov. 20, 2001

(51) Int. Cl. H04B 1/10

(52) U.S. Cl. 455/295; 455/131

(57) ABSTRACT

An enhancer that is added to a receiver to increase the dynamic range thereof. The enhancer comprises a downconverter for converting a received signal to an intermediate frequency of the receiver, and a coupler for sending the downconverted signal to the receiver. The dynamic range of the enhancer is greater than the dynamic range of the receiver such that the receiver can now receive strong signals via the enhancer. The downconverter may comprise a local oscillator that is operative to generate a local oscillator signal and a mixer operative to mix the received signal with the local oscillator signal in order to downconvert the received signal to the intermediate frequency of the receiver. In this respect, the enhancer may be an add-on device which is plugged directly into the antenna port of the receiver and immediately increases the dynamic range thereof.

### BACKGROUND OF THE INVENTION

1. Field of Invention

The present invention generally relates to receivers and more particularly an add-on device for a receiver that increases dynamic range.

2. Status of the Prior Art

Often times, a signal with a high energy level will not be tolerated by a receiver and interfere with reception of signals. More specifically, a base station may emit a signal with such a high strength that receivers nearby have insufficient dynamic range to tolerate the signals. The strong signal overpowers the receiver even if it is a different frequency.

A solution for improving the dynamic range of the receiver is to replace the front end hardware of the receiver with more tolerant devices. By replacing the front end, it is possible to increase the dynamic range of the receiver and compensate for strong signals. However, replacing the hardware of the receiver requires significant and difficult modifications which may not be practical if the receiver is in the field. Additionally, such a modification would require the receiver be taken out of service during the modification which is not desirable.

The present invention addresses the above-mentioned deficiencies in the prior art by providing an add-on device for a receiver which increases the dynamic range thereof. More specifically, the present invention provides a device which can be quickly and easily added to a receiver in order to allow the receiver to tolerate high power signals. The present invention provides a method of improving the receiver front end in cases where it is impractical to perform hardware modifications.

### SUMMARY OF THE INVENTION

In accordance with the present invention, there is provided an enhancer that is added to a receiver to increase the dynamic range thereof. The enhancer comprises a downconverter for converting a received signal to the intermediate frequency of the receiver, and a coupler for sending the downconverted signal to the receiver. The downconverter has a significantly higher dynamic range than that of the receiver. The downconverter and the enhancer thereby increase the dynamic range of the receiver.

The downconverter may comprise a local oscillator that is operative to generate a local oscillator signal and a mixer operative to mix the received signal with the local oscillator signal in order to downconvert the received signal. The local oscillator may be synchronized with the receiver via a phase lock loop that receives a control signal from the receiver via a serial buffer.

The coupler of the enhancer may be a diplexer electrically connected to the downconverter and the receiver. In this respect, the receiver may have an antenna port that is electrically connected to the mixer via the diplexer in order to couple the downconverted received signal to the receiver. The diplexer may be operative to send and receive signals between the receiver and the enhancer such that the enhancer may be operative to transmit signals as well as receive them. For instance, the enhancer may further include an antenna for detecting the received signal, as well as transmission of signals, as well as having a duplexer electrically connected to the antenna and the diplexer. The duplexer and the diplexer would be operative to transmit and receive signals with the antenna of the enhancer.

In accordance with the present invention, there is provided an add-on enhancer for increasing the dynamic range of a receiver. The add-on enhancer comprises a downconverter for converting a received signal into a downconverted signal, as well as an attachable coupling line for sending the downconverted signal to the receiver. In this respect, the enhancer is operative to increase the dynamic range of the receiver because the dynamic range of the enhancer is greater than the dynamic range of the receiver.

In accordance with the present invention, there is provided a method of increasing the dynamic range of a receiver with an enhancer constructed in accordance with a preferred embodiment. The method comprises receiving a signal with an antenna of the enhancer. Next, the signal is downconverted to an intermediate frequency of the receiver with the enhancer. Finally, the downconverted signal is coupled to the receiver via an antenna port of the receiver. Typically, the downconverted signal is coupled to the antenna port of the receiver via a coaxial line.

### BRIEF DESCRIPTION OF THE DRAWINGS

These as well as other features of the present invention may become more apparent upon reference to the drawings wherein:

FIG. 1 is a circuit diagram of a receiver intermod enhancer constructed in accordance with a preferred embodiment of the present invention.

### DETAILED DESCRIPTION OF THE PREFERRED EMBODIMENT

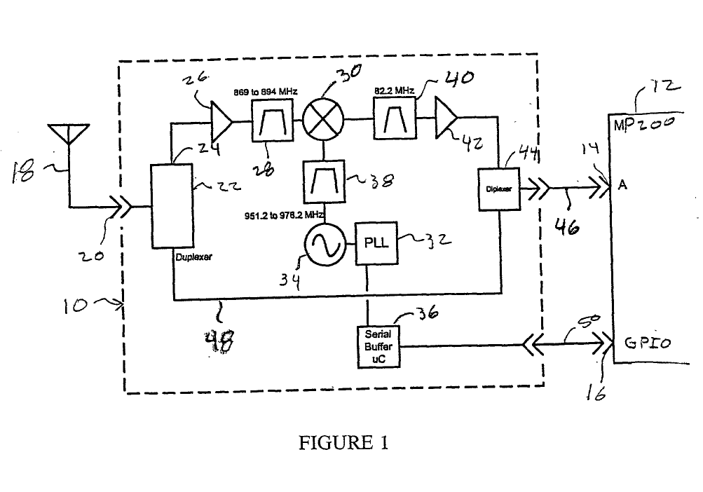

Referring now to the drawings wherein the showings are for purposes of illustrating a preferred embodiment of the present invention only, and not for purposes of limiting the same, FIG. 1 is a circuit diagram for a receiver intermod enhancer 10 constructed in accordance with the present invention. The enhancer 10 is an add-on device for a receiver 12 that is operative to detect RF radio signals. An example of such a receiver 12 is the front end of a wireless modem such as the MP200 manufactured by Sierra Wireless of Richmond, British Columbia, Canada. The receiver 12 has an antenna port 14 and a control input/output and power port GPIO 16. In normal operation, the receiver 12 receives signals through an antenna connected to the antenna port 14. However, as previously discussed above, often times a strong base signal will overpower the receiver 12 such that the receiver 12 will not have the dynamic range to detect proper signals. The enhancer 10 is operative to alleviate this deficiency by increasing the dynamic range of the receiver 12 by downconverting the received signal to the intermediate frequency, as will be further discussed below.

The enhancer 10 has an antenna 18 connected to an antenna port 20, as seen in FIG. 1. The antenna port 20 is connected to an input of a duplexer 22 of the enhancer 10. The duplexer 22 is operative to handle the full power of the receiver 12 in the transmit mode, as will be explained below. Furthermore, the duplexer 22 can also function to exclude strong signals. The duplexer 22 has a receiver port 24 connected to an input of a first amplifier 26 that increases the amplitude of the signal received by the antenna 18. The output of the first amplifier 26 is connected to an input of a first bandpass filter 28 which passes frequencies in the desired frequency range. The first bandpass filter 28 is also operative to exclude strong signals from being passed to the receiver 12.

The output of the first bandpass filter 28 is fed to a first input of a mixer 30 that downconverts the received signal to the intermediate frequency of the receiver 12. In this regard, the mixer 30 will mix the received signal in order to generate a received signal having a frequency equal to the intermediate frequency of the receiver 12. In order to avoid the generation of intermodulation products resulting from strong signals, the amplitude at which the active stages of the amplifier 26 and the mixer 30 are increased to become non-linear.

In order to mix the received signal to the intermediate frequency of the receiver 12, the enhancer 10 includes a phase lock loop (PLL) 32 and a local oscillator (LO) 34 to generate a local oscillator signal. In order to synchronize the PLL 32 and LO 34 with the receiver 12, the enhancer 10 further includes a serial buffer 36 connected to the control input/output 16 of the receiver 12 via a control line 50. In this regard, the receiver 12 can send control signals via control line 50 to the serial buffer 36 which synchronizes the PLL 32 and LO 34 to the receiver 12. The output of the LO 34 is fed to the input of a second bandpass filter 38 which removes spurious signals outside the range of the filter 38 to clean up and purify the local oscillator signal. The output of the second bandpass filter 38 is fed to a second input of the mixer 30 that downconverts the signal detected by the antenna 18, as previously mentioned.

The output of the mixer 30 is fed to an input of a third bandpass filter 40 which ensures that the frequency of the signal from the mixer 30 is the desired intermediate frequency and excludes interferers. The third bandpass filter 40 is also operative to exclude many of the intermodulation and mix products which are generated internally. The output of the third bandpass filter 40 is fed to an input of a second amplifier 42 that increases the amplitude of the signal. The output of the second amplifier 42 is fed to an input of a diplexer 44. The diplexer 44 has a port connected to the antenna port 14 of the receiver 12 via a coaxial line 46. The diplexer 44 permits the receiver 12 to send and receive signals via antenna port 14. The coaxial line 46 is a coupler which transfers the received signal from the enhancer 10 to the receiver 12.

The transmit path for signals passes from the receiver 12 through the coaxial line 46 to the diplexer 44. The diplexer 44 would then transmit the signal over transmit line 48 to the duplexer 22. The duplexer 22 is operative to send the signal to the antenna 18 via antenna port 20 in order to transmit the signal.

In the preferred embodiment of the present invention, the enhancer 10 is designed to be added onto a receiver 12 which receives CDPD signals. Accordingly, the enhancer 12 would downconvert the CDPD signals to the intermediate frequency of 82.2 MHZ. As such, the first bandpass filter 28 would have a pass band from 869 MHZ to 894 MHZ. The third bandpass filter 40 would have a pass band of 82.185 MHZ to 82.215 MHZ to exclude interferers. The second bandpass filter 38 would have a pass band from 951.2 MHZ to 976.2 MHZ. The pass band of the second bandpass filter 38 corresponds to the frequency of the signal that is mixed with the received signal to generate the downconverted 82.2 MHZ signal.

The enhancer 10 has an increased dynamic range over the front end of the receiver 12. The enhancer 10 increases the 1 dB compression point of the receiver 12 to a high value, significantly higher than that of the receiver, for example 0 dBm, without degrading other performance parameters. The signal from the enhancer 10 would be coupled to the receiver 12 at 82.2 MHZ at a relatively high level and rely on IF Blowthrough in the receiver 12 for demodulation. IF Blowthrough is the inherent weakness of a superheterodyne receiver that allows it to receive input signals at its IF frequency. It is the result of non-ideal isolation of the IF stages from the antenna input. By utilizing IF Blowthrough, it is not necessary to convert the signal back up to the carrier frequency for input into the receiver 12 at the antenna port 14. Accordingly, the receiver 12 will demodulate the signal at 82.2 MHZ. Additionally, issues of re-radiation and interference with other receivers are avoided because the signal remains at the intermediate frequency (i.e., 82.2 MHZ) which radiates poorly and is received poorly by nearby receivers.

The enhancer 10 is operative to increase the dynamic range of the receiver 12 without expensive modifications thereto. As described above, the dynamic range of the enhancer 10 can be greater than the receiver 12 such that the enhancer 10 can tolerate strong signals from a base station. By coupling the enhancer 10 to the existing antenna port 14 of the receiver 12 it is easy to add the enhancer 10 to the system. Accordingly, the antenna port 14, as well as the control input/output 16 may be configured as standard ports within which coaxial line 46 and control line 50 can be connected respectively. It will be recognized that by plugging in the coaxial line 46 and the control line 50 into the receiver 12, the enhancer 12 is quickly added. It may be necessary to update the software of the receiver 12 in order for the receiver 12 to operate properly with the enhancer 10 and to provide the proper control signals via control input/output 16 for synchronization. Furthermore, the control input/output 16 may include a dedicated power line which can supply power to the enhancer 10 (if needed).

Of course, it will be recognized that the duplexer 22, transmit line 48 and duplexer 44 allow the transmission and reception of signals over a common antenna 18. These elements do not add anything to enhance the dynamic range of the receiver 12 and could be excluded if desired.

Additional modifications and improvements of the present invention may also be apparent to those of ordinary skill in the art such as modifying the enhancer for different frequency bands and IF frequencies. Thus, the particular combination of parts described and illustrated herein is intended to represent only a certain embodiment of the present invention, and is not intended to serve as a limitation of alternative devices within the spirit and scope of the invention.

1. An enhancer for increasing the dynamic range of a receiver that detects a signal, the enhancer comprising:
a downconverter for downconverting the received signal; and
a coupler for sending the downconverted signal to the receiver;
wherein the downconverter and the enhancer increase the dynamic range of the receiver.

2. The enhancer of claim 1 further including at least one filter operative to exclude strong signals.

3. The enhancer of claim 1 wherein the downconverter comprises:
a local oscillator operative to generate a local oscillator signal; and
a mixer operative to mix the received signal with the local oscillator signal in order to downconvert the received signal.

4. The enhancer of claim 3 wherein the receiver comprises an antenna port and the coupler is operative to couple the downconverted signal to the antenna port of the receiver.

5. The enhancer of claim 3 wherein the mixer is operative to downconvert the received signal to the intermediate frequency of the receiver.

6. The enhancer of claim 5 wherein the local oscillator is synchronized to the receiver.

7. The enhancer of claim 6 further comprising a phase lock loop electrically connected to the local oscillator and the receiver in order to synchronize the local oscillator.

8. The enhancer of claim 7 further comprising a serial buffer electrically connected to the phase lock loop and the receiver in order to synchronize the local oscillator.

9. The enhancer of claim 3 wherein the coupler is a coaxial line operative to couple the enhancer to the receiver.

10. The enhancer of claim 9 further comprising:
an antenna for detecting the received signal; and
a duplexer electrically connected to the coupler and the antenna, the duplexer operative to transmit and receive signals to and from the coupler.

11. An add-on enhancer to increase the dynamic range of a receiver having an antenna port, the enhancer comprising:
a downconverter for downconverter a received signal to an intermediate frequency of the receiver; and
an attachable coupling line for sending signals from the downconverter to the receiver;
wherein the dynamic range of the enhancer is greater than the dynamic range of the receiver.

12. The add-on enhancer of claim 11 further comprising at least one filter operative to exclude strong signals.

13. The add-on enhancer of claim 11 wherein the downconverter comprises a mixer and a local oscillator operative to downconvert the received signal to the intermediate frequency of the receiver.

14. The add-on enhancer of claim 13 wherein the local oscillator is synchronized to the receiver.

15. The add-on enhancer of claim 14 further comprising a control signal from the receiver to the local oscillator in order to synchronize the local oscillator to the receiver.

16. The add-on enhancer of claim 15 further comprising a phase lock loop in electrical communication with the local oscillator and the control signal in order to facilitate synchronization.

17. The add-on enhancer of claim 13 further comprising a diplexer in electrical communication with the downconverter and the coupling line.

18. The add-on enhancer of claim 17 further comprising an antenna in electrical communication with the downconverter and operative to detect the received signal.

19. The add-on enhancer of claim 18 further comprising a duplexer in electrical communication with the antenna and the diplexer, the duplexer being operative to transmit and receive signals with the antenna.

20. The add-on enhancer of claim 19 wherein the diplexer and the duplexer are operative to send and receive signals between the antenna of the add-on enhancer and the antenna port of the receiver.

21. A method of increasing the dynamic range of a receiver having an antenna port with an enhancer, the method comprising the steps of:
a) receiving a signal with an antenna of the enhancer;
b) downconverting the signal to an intermediate frequency of the receiver; and
c) coupling the downconverted signal to the antenna port of the receiver.

22. The method of claim 21 further comprising the step of filtering the received signal in order to exclude strong signals.

23. The method of claim 21 wherein step (b) comprises mixing the signal in order to downconvert the signal.

24. The method of claim 23 wherein step (b) comprises mixing the signal with a local oscillator signal.

25. The method of claim 24 further comprising the step of synchronizing the local oscillator signal with the receiver.

26. The method of claim 25 further comprising the step of synchronizing the local oscillator signal via a control signal from the receiver.

27. The method of claim 26 wherein step (c) comprises coupling the downconverted signal with a coaxial line in electrical communication with the antenna port of the receiver.

28. An enhancer for increasing the dynamic range of a receiver, the enhancer comprising:
downconversion means for downconverting a signal detected by an antenna of the enhancer; and
coupling means for sending the downconverted received signal to the receiver.

29. An enhancer for increasing the dynamic range of a receiver having an antenna port, the enhancer comprising:
an antenna for receiving the a signal;
a mixer in electrical communication with the antenna and a local oscillator signal; the mixer being operative to downconvert the received signal to an intermediate frequency of the receiver; and
a coupler in electrical communication with the mixer and the antenna port of the receiver, the coupler being operative to transmit the downconverted received signal to the receiver.

30. The enhancer of claim 29 further comprising:
a duplexer in electrical communication with the antenna and the mixer; and
a diplexer in electrical communication with the duplexer, the mixer and the antenna port of the receiver;
wherein the duplexer and the diplexer are operative to send a receive signal between the antenna and the antenna port of the receiver.

31. The enhancer of claim 30 further comprising a local oscillator in electrical communication with the mixer, the local oscillator being operative to provide a local oscillator signal to the mixer to be downconverted with the received signal.

32. The enhancer of claim 31 further comprising a phase lock loop in electrical communication with the local oscillator and the receiver, the phase lock loop being operative to synchronize the local oscillation signal with the receiver.
